(19) United States
(12) Patent Application Publication
(10) Pub. No.: US 2007/0078750 A1
(43) Pub. Date: Apr. 5, 2007

(54) Method of and a system for video editing on a computer network

(76) Inventor: Steven Rosenbaum, New York, NY (US)

Correspondence Address: Ilya Zborovsky, 6 Schoolhouse Way, Dix Hills, NY, 11746, US

(21) Appl. No.: 11/241,622

(22) Filed: Oct. 3, 2005

(51) Int. Cl. G06Q 40/00

(52) U.S. Cl. 705/37

(57) ABSTRACT

Editing a video project via a computer network, includes submitting a video project by a submitter, receiving the proposed video product, reviewing the submitted video product by potential editors and bidding for the submitted video product, and choosing by the submitter of the video product an editor who won the bidding.

### BACKGROUND OF THE INVENTION

The present invention relates to a method of and a system for editing video products on a computer network.

People who shoot films often find themselves with a large amount of video tape and no clear way to find an editor. Currently there is all word of mouth & ordinary bulletin board postings. It is believed to be advisable to create a new method and a system for a substantial improvement of the existing situation.

### SUMMARY OF THE INVENTION

Accordingly, it is an object of the present invention to provide a method of and a system for editing video products, which is a further improvement in this art.

In keeping with these objects and with others which will become apparent hereinafter, one feature of the present invention resides, briefly stated, in a method of facilitating editing a video product via a computer network, comprising the steps of submitting a video project by a submitter; receiving the proposed video project; reviewing the submitted video project by potential editors and bidding for the submitted video project; a choosing by the submitter of the video project an editor who won the bidding.

In accordance with another embodiment of the present invention, after receiving the bids from editors, an auction is closed and the submitter of the video project is allowed to choose bidder who won.

In accordance with another embodiment of the present invention, an escrow account for funds is provided so that the editor is assured of payment of the editing which he did.

In accordance with still a further embodiment of the present invention, access is provided to information about the submitted video project, and the editor who edited the video product, so that editing of the submitted video product by the editor becomes widely known. This will include a video portfolio of the finished work.

In accordance with still a further embodiment of the present invention, a commission is provided in an event if the video product is submitted by submitter and edited by the editor.

In accordance with the present invention also a system is proposed for editing a video product on a computer network, including means for submitting a video project by a submitter; means for receiving the proposed video project; means for reviewing the submitted video project by potential editors and bidding for the submitted video project; means for a choosing by the submitter of the video project an editor who won the bidding.

Finally, in accordance with the present invention also, a computer readable medium for implementing a method of editing a video product is proposed, the method including submitting a video product by a submitter; receiving the proposed video product; reviewing the submitted video product by potential editors and bidding for the submitted video product; a choosing by the submitter of the video product an editor who won the bidding.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a block diagram illustrating an exemplary computer network for implementing the present invention; and

FIG. 2 is a flow chart of an exemplary process for implementing a method of and a system for video editing on a computer network in accordance with the present invention.

### DESCRIPTION OF THE PREFERRED EMBODIMENTS

In accordance with the method and system of the present invention an operator may set up a computer network site acceptable by various users of the network. The network site may be, for example, a website accessible over the Internet or World Wide Web.

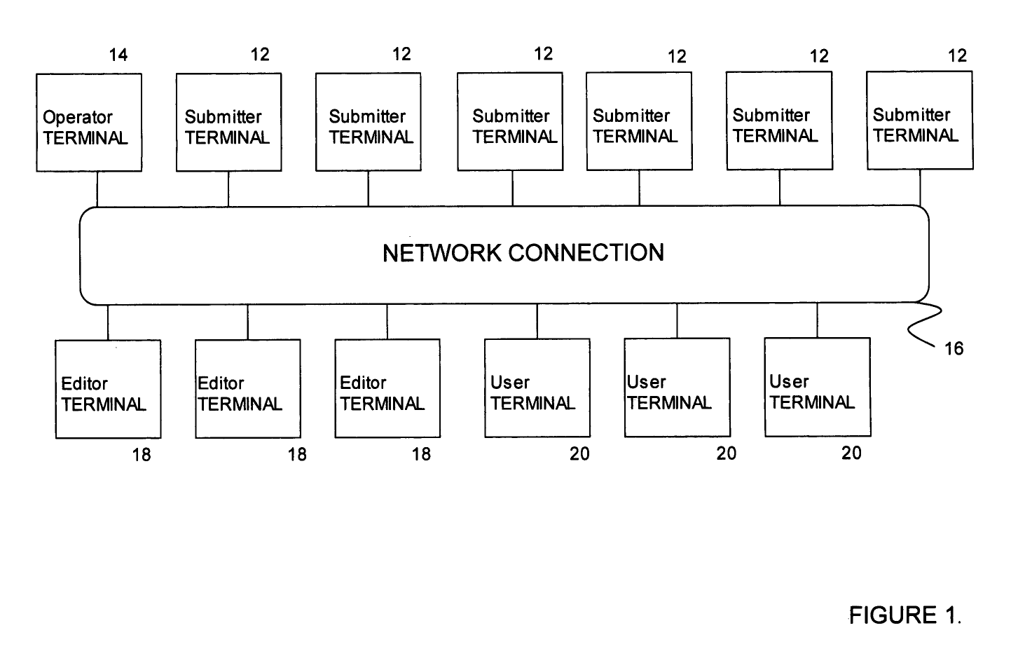

Referring now to FIG. 1, it shows an exemplary computer network 10 for the present invention. A plurality of submitter terminals 12 may communicate with one or more operator servers 14 over a network connection 16. Although the computer network 10 is preferably an Internet-based network such as the World Wide Web, it may be one or more of a local area network (LAN), a wide-area network (WAN) an Intranet environment, an Extranet environment, a wireless network or any other type of computer network, such as those enabled over public switched telephone network.

Editor terminals 18 may communicate with the operator server 14 also over the network connection 16. Furthermore, user terminals 20 also may communicate with the operator server 14 through the network connection 16.

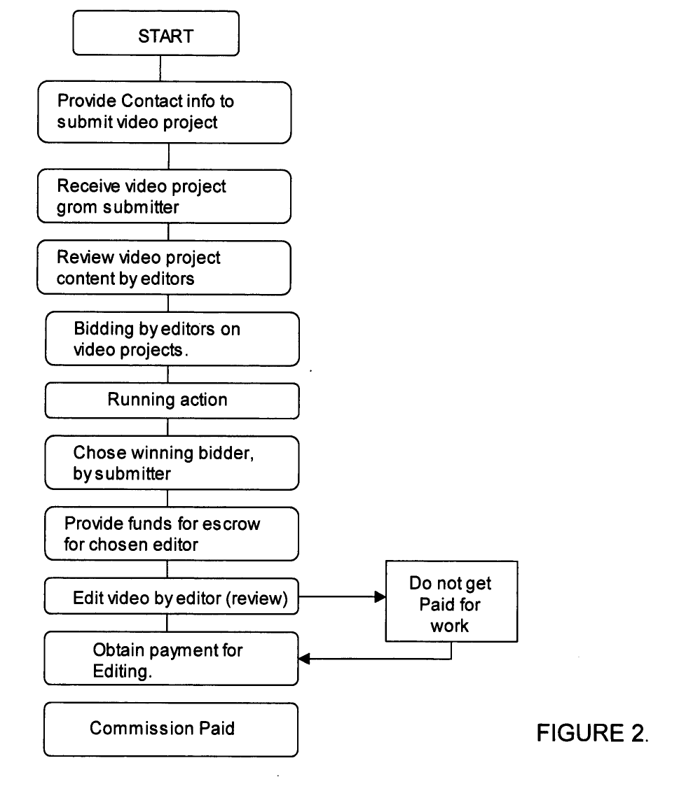

Turning now to FIG. 2, this figure shows an exemplary process 30 for editing video products in accordance with the present invention. The process 30 begins at step 31, where the network side maintained by the operator=s server 14 provides contact information to submit video products. Any video products can be submitted, such as large amount of video tapes or short videos, home videos, weddings, corporate and industrial videos, etc.

Continuing the process, the video project submitted by a submitter is received in step 32. The video product can include video contents, concepts, tape information, projects, etc. to be reviewed by potential editors.

In step 33 editors review the video products submitted by the submitters, and in step 34 they bid on video products which they would like to pursue by editing them. The operator server 14 runs an auction in step 35, closes the auction, and allows the submitter of the video product to choose an editor who wins the bid, in step 36.

An escrow account can be provided for funds in step 37, so that the editor is assured of payment at the end of his editing job. In step 37 the submitted video product is edited by the chose editor. In step 39 the editor obtains a payment for his editing job.

It is also possible that the editing is performed on a barter basis without payment, in step 40. In this case no money changes hands, however the fact that a certain editor edits a certain product becomes accessible to users of involved community. The editing of the video products with payments obtained can be performed, in step 41.

Users can access the network from user terminals 20 through the network connection 16. Finally in step 42 commissions can be obtained for the transactions by the operator.

It will be understood that each of the elements described above, or two or more together, may also find a useful application in other types of methods and systems differing from the types described above.

While the invention has been illustrated and described as embodied in a method of and system for video editing on a computer network, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A method of editing a video project on a computer network, comprising the steps of submitting a video project by a submitter; receiving the submitted video project; reviewing the submitted video project by potential editors and bidding for the submitted video project; and choosing by the submitter of the video product an editor who won the bidding.

2. A method as defined in claim 1; and further comprising after receiving the bids from editors, closing an auction and allowing the submtiter of the video product to choose bidder who won.

3. A method as defined in claim 1; and further comprising providing an escrow account for funds so that the editor is assured of payment for editing which he did. The funds in escrow are released in a 3 phase payment, so as video editing is commenced, rough cut, and complete, funds are releaed.

4. A method as defined in claim 3; and further providing access to information about the submitted and edited video product, as well as about the submitter and about the editor who edited the video product and received a payment.

5. A method as defined in claim 1; and further comprising providing access to information about the submitted video product, as well as about the submitter and about the editor who edited the video product without payment, so that editing of the submitted video product by the editor becomes widely known. This includes a video portfolio for the editor to display his work.

6. A method as defined in claim 1; and further comprising editing of the submitted video product by the editor who won the bidding.

7. A method as defined in claim 1; and further comprising providing a commission in an event if the video product is submitted by submitter and edited by the editor.

8. A system for editing video products, comprising means for submitting a video product by a submitter; means for receiving the proposed video product; means for reviewing the submitted video product by potential editors and bidding for the submitted video product; and means for choosing by the submitter of the video product an editor who won the bidding.

9. A computer readable medium for implementing a method of editing a video project, the method comprising the steps of submitting a video project by a submitter; receiving the proposed video project; reviewing the submitted video project by potential editors and bidding for the submitted video project; and choosing by the submitter of the video project an editor who won the bidding.
